(19) United States
(12) Patent Application Publication
(10) Pub. No.: US 2024/0260035 A1
(43) Pub. Date: Aug. 1, 2024

(54) METHOD AND APPARATUS FOR PHYSICAL DOWNLINK SHARED CHANNEL (PDSCH) REPETITION IN WIRELESS COMMUNICATION SYSTEM

(71) Applicant: Samsung Electronics Co., Ltd., Suwon-si (KR)

(72) Inventors: Deokhui LEE, Suwon-si (KR); Dongmyung KIM, Suwon-si (KR); Sunhyun KIM, Suwon-si (KR); Bongsung SEO, Suwon-si (KR)

(21) Appl. No.: 18/181,919

(22) Filed: Mar. 10, 2023

(30) Foreign Application Priority Data
Jan. 31, 2023 (KR) 10-2023-0012446

(51) Int. Cl. H04W 72/1273; H04L 1/00; H04L 1/1812; H04W 72/23

(52) U.S. Cl. CPC H04W 72/1273; H04L 1/0004; H04L 1/1812; H04W 72/23

(57) ABSTRACT

The present disclosure relates to a 5G communication system or a 6G communication system for supporting higher data rates beyond a 4G communication system such as long term evolution (LTE). A method performed by a terminal for physical downlink shared channel (PDSCH) repetition in the 5G or 6G communication system is provided. The method includes receiving downlink control information (DCI) which schedules a plurality of PDSCHs from a base station on a physical downlink control channel (PDCCH), receiving a first PDSCH of a first modulation and coding scheme (MCS) level from the base station based on the DCI, and, if failing in decoding the first PDSCH, receiving a second PDSCH of a second MCS level from the base station based on the DCI.

### CROSS-REFERENCE TO RELATED APPLICATION(S)

This application is based on and claims priority under 35 U.S.C. § 119(a) of a Korean patent application number 10-2023-0012446, filed on Jan. 31, 2023, in the Korean Intellectual Property Office, the disclosure of which is incorporated by reference herein in its entirety.

### BACKGROUND

### 1. Field

The disclosure relates to a wireless communication system. More particularly, the disclosure relates to a method and an apparatus for physical downlink shared channel (PDSCH) repetition in the wireless communication system.

### 2. Description of Related Art

Considering the development of wireless communication from generation to generation, the technologies have been developed mainly for services targeting humans, such as voice calls, multimedia services, and data services. Following the commercialization of 5G (5th generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bit per second (bps) and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz (THz) band (for example, 95 gigahertz (GHz) to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, Radio Frequency (RF) elements, antennas, novel waveforms having a better coverage than Orthogonal Frequency Division Multiplexing (OFDM), beamforming and massive Multiple-input Multiple-Output (MIMO), Full Dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, Orbital Angular Momentum (OAM), and Reconfigurable Intelligent Surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, High-Altitude Platform Stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of Artificial Intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as Mobile Edge Computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended Reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and a method for effectively providing a service in a wireless communication system.

Additional aspects will be set forth in part in the description which follows and, in part, will be apparent from the description, or may be learned by practice of the presented embodiments.

In accordance with an aspect of the disclosure, a method performed by a terminal for physical downlink shared channel (PDSCH) repetition in a wireless communication system is provided. The method includes receiving downlink control information (DCI) which schedules a plurality of PDSCHs from a base station on a physical downlink control channel (PDCCH), receiving a first PDSCH of a first modulation and coding scheme (MCS) level from the base station based on the DCI, and, if failing in decoding the first PDSCH, receiving a second PDSCH of a second MCS level from the base station based on the DCI, the first MCS level and the second MCS level may be indicated through the DCI, and the second MCS level may be smaller than the first MCS level.

In accordance with another aspect of the disclosure, a method performed by a base station for PDSCH repetition in a wireless communication system is provided. The method includes transmitting DCI which schedules a plurality of PDSCHs to a terminal on a PDCCH, transmitting a first PDSCH of a first MCS level to the terminal based on the DCI, and transmitting a second PDSCH of a second MCS level to the terminal based on the DCI, the first MCS level and the second MCS level may be indicated through the DCI, and the second MCS level may be smaller than the first MCS level.

In accordance with another aspect of the disclosure, a terminal in a wireless communication system is provided. The terminal includes at least one transceiver and at least one processor functionally coupled with the at least one transceiver, the at least one processor may be configured to receive DCI which schedules a plurality of PDSCHs from a base station on a PDCCH, receive a first PDSCH of a first MCS level from the base station based on the DCI, and, if failing in decoding the first PDSCH, receive a second PDSCH of a second MCS level from the base station based on the DCI, the first MCS level and the second MCS level may be indicated through the DCI, and the second MCS level may be smaller than the first MCS level.

In accordance with another aspect of the disclosure, a base station in a wireless communication system is provided. The base station includes at least one transceiver and at least one processor functionally coupled with the at least one transceiver, the at least one processor may be configured to transmit DCI which schedules a plurality of PDSCHs to a terminal on a PDCCH, transmit a first PDSCH of a first MCS level to the terminal based on the DCI, and transmit a second PDSCH of a second MCS level to the terminal based on the DCI, the first MCS level and the second MCS level may be indicated through the DCI, and the second MCS level may be smaller than the first MCS level.

Various embodiments of the disclosure provide an apparatus and a method for effectively providing a service in a wireless communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of a wireless communication environment according to an embodiment of the disclosure;

FIG. 2 illustrates an example of a base station configuration in a wireless communication system according to an embodiment of the disclosure;

FIG. 3 illustrates an example of a terminal configuration in a wireless communication system according to an embodiment of the disclosure;

FIG. 4 illustrates statistical parameters of a single stream downlink (DL) virtual reality (VR) traffic model according to an embodiment of the disclosure;

FIG. 5 illustrates statistical parameters of a multi-stream DL VR traffic model according to an embodiment of the disclosure;

FIG. 6 illustrates modulation and coding scheme (MCS) adaptation for a signal to interference plus noise ratio (SINR) according to an embodiment of the disclosure;

FIG. 7 illustrates latency in hybrid automatic repeat and request (HARQ) retransmission of a dynamic grant according to an embodiment of the disclosure;

FIG. 8 illustrates HARQ retransmissions with different redundancy versions (RVs) according to an embodiment of the disclosure;

FIG. 9 illustrates a concept of a physical downlink shared channel (PDSCH) repetitive transmission due to MCS level decrease according to an embodiment of the disclosure;

FIG. 10 illustrates a PDSCH repetitive transmission in a mini slot according to an embodiment of the disclosure;

FIG. 11 illustrates a PDSCH repetitive transmission in a slot according to an embodiment of the disclosure;

FIG. 12 illustrates PDSCH repetitive transmissions in a group of pictures (GOP) frame according to an embodiment of the disclosure;

FIG. 13 illustrates an embodiment of control information configuration for each PDSCH repetition according to an embodiment of the disclosure;

FIG. 14 illustrates an embodiment of control information configuration for each PDSCH repetition according to an embodiment of the disclosure;

FIG. 15 illustrates an embodiment of control information configuration for each PDSCH repetition according to an embodiment of the disclosure;

FIG. 16 illustrates an embodiment of control information configuration for PDSCH repetition according to an embodiment of the disclosure;

FIG. 17 illustrates PDSCH repetitive transmissions with different physical resource block (PRB) positions according to an embodiment of the disclosure;

FIG. 18 illustrates a flowchart of a terminal according to an embodiment of the disclosure; and

FIG. 19 illustrates signal flows between a terminal and a base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

All terms used herein, including technical and scientific terms, may have the same meaning as those commonly understood by a person skilled in the art of the disclosure. Terms defined in a generally used dictionary among the terms used in the disclosure may be interpreted to have the meanings equal or similar to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

Various embodiments of the disclosure to be described explain a hardware approach by way of example. However, since the various embodiments of the disclosure include a technology using both hardware and software, various embodiments of the disclosure do not exclude a software based approach.

Terms indicating device components (a control unit, a processor, an artificial intelligence (AI) model, an encoder, a decoder, an autoencoder (AE), a neural network (NN) model, etc.) and terms indicating data (a signal, a feedback, a report, reporting, information, a parameter, a value, a bit, a codeword, etc.) used in the following explanation are illustrated only for convenience of description. Accordingly, the disclosure is not limited to the terms to be described, and other terms indicating targets having the same technical meaning may be used.

Hereinafter, embodiments of the disclosure are described in detail with reference to the accompanying drawings.

In describing the embodiments, technical contents well known in the technical field to which the disclosure pertains and which are not directly related to the disclosure will be omitted in the specification. This is to more clearly provide the subject matter of the disclosure by omitting unnecessary descriptions without obscuring the subject matter of the disclosure.

For the same reason, some components in the accompanying drawings are exaggerated, omitted, or schematically illustrated. Also, a size of each component does not entirely reflect an actual size. The same reference number is given to the same or corresponding element in each drawing.

Advantages and features of the disclosure, and methods for achieving them will be clarified with reference to embodiments described below in detail together with the accompanying drawings. However, the disclosure is not limited to the embodiments disclosed below but may be implemented in various different forms, the embodiments are provided to only complete the scope of the disclosure and to allow those skilled in the art to which the disclosure pertains to fully understand a category of the disclosure, and the disclosure is solely defined within the scope of the claims. The same reference numeral refers to the same element throughout the specification.

At this time, it will be understood that each block of the process flowchart illustrations and combinations of the flowchart illustrations may be executed by computer program instructions. Since these computer program instructions may be mounted on a processor of a general purpose computer, a special purpose computer or other programmable data processing apparatus, the instructions executed by the processor of the computer or other programmable data processing equipment may generate means for executing functions described in the flowchart block(s). Since these computer program instructions may also be stored in a computer-usable or computer-readable memory which may direct a computer or other programmable data processing equipment to function in a particular manner, the instructions stored in the computer-usable or computer-readable memory may produce a manufacture article including instruction means which implement the function described in the flowchart block(s). Since the computer program instructions may also be loaded on a computer or other programmable data processing equipment, a series of operational steps may be performed on the computer or other programmable data processing equipment to produce a computer-executed process, and thus the instructions performing the computer or other programmable data processing equipment may provide steps for executing the functions described in the flowchart block(s).

In addition, each block may represent a portion of a module, a segment or code which includes one or more executable instructions for implementing a specified logical function(s). Also, it should be noted that the functions mentioned in the blocks may occur out of order in some alternative implementations. For example, two blocks shown in succession may in fact be executed substantially concurrently or the blocks may sometimes be executed in the reverse order depending on corresponding functionality.

At this time, the term ‘˜unit’ as used in the embodiment indicates software or a hardware component such as a field programmable gate array (FPGA) or an application-specific integrated circuit (ASIC), and ‘˜unit’ performs specific roles. However, ‘˜unit’ is not limited to software or hardware. ‘˜unit’ may be configured to reside on an addressable storage medium and configured to reproduce on one or more processors. Accordingly, ‘˜unit’ may include, for example, components such as software components, object-oriented software components, class components and task components, processes, functions, attributes, procedures, sub-routines, segments of program code, drivers, firmware, microcode, circuitry, data, databases, data structures, tables, arrays, and variables. The functionalities provided in the components and ‘˜unit’ may be combined to fewer components and ‘˜units’ or may be further separated into additional components and ‘˜units’. Further, the components and ‘˜units’ may be implemented to reproduce one or more central processing units (CPUs) within a device or a security multimedia card. Also, ‘˜unit’ in one embodiment may include one or more processors.

The specific description of embodiments of the disclosure is mainly based on a new radio (NR) which is a radio access network and a packet core 5th generation (5G) system, a 5G core network, or a next generation (NG) core which is a core network on 5G mobile communication standards specified by 3rd generation partnership project (3GPP) which is a mobile communication standardization organization, but the main subject of the disclosure may be applied to other communication systems having a similar technical background with slight modification without departing from the scope of the disclosure, which may be determined by those skilled in the art of the disclosure. Further, it may be also applied to a beyond 5G mobile communication system or a 6G mobile communication system to emerge in 10 years.

Hereafter, for the convenience of description, some of terms and names defined in the 3GPP standard (5G, NR, long term evolution (LTE), or a similar system standard) may be used. However, the disclosure is not limited by these terms and names, and may be applied to systems conforming to other standards in the same manner.

Hereafter, in the following description, terms for identifying access nodes, terms indicating network entities, terms indicating messages, terms indicating interfaces between network entities, terms indicating various identification information, and the like are illustratively used for the sake of convenience. Accordingly, the disclosure is not limited by the terms to be used, and other terms indicating subjects having equivalent technical meanings may be used.

A radio access network (RAN) indicates a technology used for wireless communication between a base station and a terminal, such as 5G-NR, evolved universal terrestrial radio access network (E-UTRAN), universal terrestrial radio access network (UTRAN), or global system for mobile communications (GSM) enhanced data rates for GSM evolution (EDGE) RAN (GERAN), and the terminal may receive a communication service by accessing a base station, an eNodeB (eNB) or a gNodeB (gNB) supporting mobile communication technology for the wireless communication. The base station may transmit control signals or data received from terminal(s) to a device residing in a core network by interworking with the core network to receive configuration, transmit and receive data, or perform procedures for management. Besides, the terminal may connect to a data network using a technology using a sidelink, such as proximity service (Prose) which performs direction communication between terminals without connecting to the base station or a non-3GPP radio access technique such as Wi-Fi or Bluetooth.

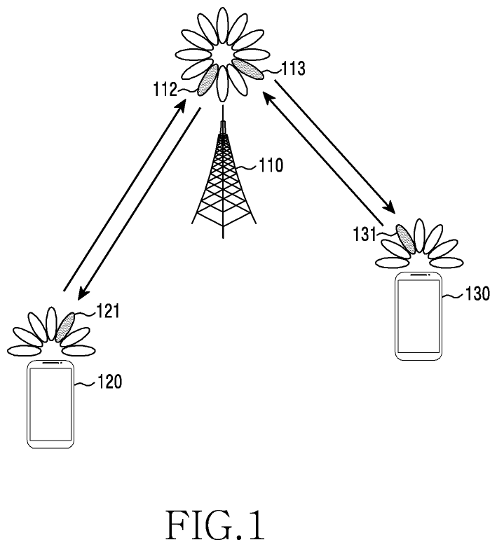

FIG. 1 illustrates a wireless communication system according to an embodiment of the disclosure. FIG. 1 illustrates a base station 110, a terminal 120, and a terminal 130, as some of nodes using radio channels in the wireless communication system. Although FIG. 1 illustrates only one base station, other base station which is the same as or similar to the base station 110 may further be included.

Referring to FIG. 1, the base station 110 is a network infrastructure which provides radio access to the terminals 120 and 130. The base station 110 has coverage defined as a specific geographic region based on a signal transmission distance. The base station 110 may be referred to as, beside the base station, an ‘access point (AP)’, an ‘eNodeB (eNB)’, a ‘gNodeB (gNB)’, a ‘5G node’, a ‘6G node’, a ‘wireless point’, a ‘transmission/reception point (TRP)’, or other term having technically identical meaning. Hereafter, the base station may indicate at least one of the AP, the eNB, the gNB, the 5G node, the 6G node, the wireless point, or the TRP in embodiments of the disclosure.

The terminal 120 and the terminal 130 each are a device is used by a user, and communicate with the base station 110 over the radio channel. In some cases, at least one of the terminal 120 or the terminal 130 may be operated without user's involvement. That is, at least one of the terminal 120 or the terminal 130 may be a device which performs machine type communication (MTC), and may not be carried by the user. The terminal 120 and the terminal 130 each may be referred to as, beside the terminal, a ‘user equipment (UE)’, a ‘mobile station’, a ‘subscriber station’, a ‘customer premises equipment (CPE)’, a ‘remote terminal’, a ‘wireless terminal’, an ‘electronic device’, or a ‘user device’, or other term having technically identical meaning.

The base station 110, the terminal 120, and the terminal 130 may transmit and receive a radio signal in a millimeter wave (mm Wave) band (e.g., 28 GHz, 30 GHZ, 38 GHz, 60 GHz, over 60 GHz, etc.). In so doing, to improve a channel gain, the base station 110, the terminal 120, and the terminal 130 may perform beamforming. Herein, the beamforming may include transmit beamforming and receive beamforming. That is, the base station 110, the terminal 120, and the terminal 130 may give directivity to a transmit signal or a receive signal. For doing so, the base station 110 and the terminals 120 and 130 may select serving beams 112, 113, 121, and 131 through a beam search or beam management procedure. After the serving beams 112, 113, 121, and 131 are selected, communication may be performed through resources which are quasi co-located (QCL) with resources transmitting the serving beams 112, 113, 121, and 131.

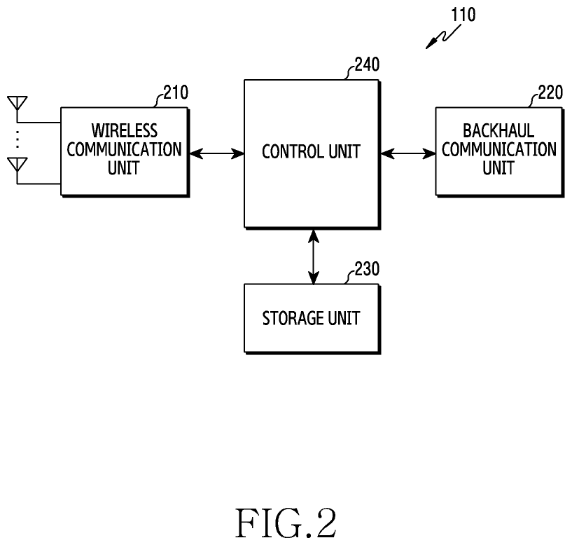

FIG. 2 illustrates an example of a base station configuration in a wireless communication system according to an embodiment of the disclosure. According to various embodiments of the disclosure, a base station 110 may be referred to as a network for the sake of convenience. The configuration illustrated in FIG. 2 may be understood as the configuration of the base station 110. A term such as ‘˜ unit’ or ‘˜ er’ used hereafter indicates a unit for processing at least one function or operation, and may be implemented using hardware, software, or a combination of hardware and software.

Referring to FIG. 2, the base station 110 may include a wireless communication unit 210, a backhaul communication unit 220, a storage unit 230, and a control unit 240.

The wireless communication unit 210 performs functions for transmitting and receiving a signal over a radio channel. For example, the wireless communication unit 210 performs a conversion function between a baseband signal and a bit string according to a physical layer standard of the system. For example, in data transmission, the wireless communication unit 210 generates complex symbols by encoding and modulating a transmit bit string. Also, in data reception, the wireless communication unit 210 restores a receive bit string by demodulating and decoding a baseband signal. Also, the wireless communication unit 210 up-converts the baseband signal into a radio frequency (RF) band signal, transmits it via an antenna, and down-converts an RF band signal received via an antenna into a baseband signal.

For doing so, the wireless communication unit 210 may include a transmit filter, a receive filter, an amplifier, a mixer, an oscillator, a digital to analog convertor (DAC), an analog to digital convertor (ADC), and so on. In addition, the wireless communication unit 210 may include a plurality of transmit and receive paths. Further, the wireless communication unit 210 may include at least one antenna array including a plurality of antenna elements. In terms of the hardware, the wireless communication unit 210 may include a digital unit and an analog unit, and the analog unit may include a plurality of sub-units according to an operating power, an operating frequency and the like.

The wireless communication unit 210 may transmit and receive a signal. For doing so, the wireless communication unit 210 may include at least one transceiver. For example, the wireless communication unit 210 may transmit a synchronization signal, a reference signal, system information, a message, control information, or data. The wireless communication unit 210 may perform the beamforming.

The wireless communication unit 210 transmits and receives the signal as stated above. Hence, whole or part of the wireless communication unit 210 may be referred to as ‘a transmitter’, ‘a receiver’, or ‘a transceiver’. Also, in the following explanations, the transmission and the reception over the radio channel are used as the meaning which embraces the above-stated processing of the wireless communication unit 210.

The backhaul communication unit 220 provides an interface for communicating with other nodes in the network. That is, the backhaul communication unit 220 converts a bit sting transmitted from the base station 110 to other node, for example, other access node, other base station, an upper node, or a core network, into a physical signal, and converts a physical signal received from the other node into a bit string.

The storage unit 230 stores a basic program for operating the base station 110, an application program, and data such as setting information. The storage unit 230 may include a memory. The storage unit 230 may include a volatile memory, a non-volatile memory, or a combination of a volatile memory and a non-volatile memory. The storage unit 230 provides the stored data at a request of the control unit 240.

The control unit 240 controls general operations of the base station 110. For example, the control unit 240 transmits and receives the signal through the wireless communication unit 210 or the backhaul communication unit 220. Also, the control unit 240 records and reads data in and from the storage unit 230. The control unit 240 may execute functions of a protocol stack requested by a communication standard. For doing so, the control unit 240 may include at least one processor.

The configuration of the base station 110 shown in FIG. 2 is merely the example of the base station, and the example of the base station for carrying out various embodiments of the disclosure is not limited from the configuration shown in FIG. 2. That is, some configuration may be added, deleted, or changed, according to various embodiments.

FIG. 2 has described the base station as one entity, but the disclosure is not limited thereto. The base station according to various embodiments of the disclosure may be implemented to build an access network having distributed deployment as well as integrated deployment. According to an embodiment, the base station may be divided into a central unit (CU) and a digital unit (DU), the CU may be implemented to perform upper layers (e.g., radio link control (RLC), packet data convergence protocol (PDCP) and radio resource control (RRC)) and the DU may be implemented to perform lower layers (e.g., medium access control (MAC), physical (PHY)). The DU of the base station may form beam coverage on the radio channel.

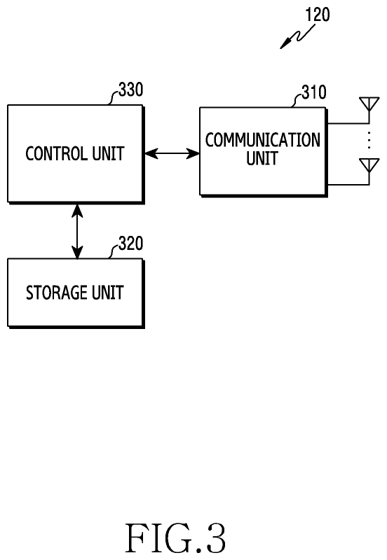

FIG. 3 illustrates a configuration of a terminal in a wireless communication system according to an embodiment of the disclosure. The configuration illustrated in FIG. 3 may be understood as the configuration of the terminal 120 and 130. A term such as ‘portion’ or ‘˜er’ used hereafter indicates a unit for processing at least one function or operation, and may be implemented using hardware, software, or a combination of hardware and software.

Referring to FIG. 3, the terminals 120 and 130 may include a communication unit 310, a storage unit 320, and a control unit 330.

The communication unit 310 performs functions for transmitting and receiving a signal over a radio channel. For example, the communication unit 310 performs a conversion function between a baseband signal and a bit string according to the physical layer standard of the system. For example, in data transmission, the communication unit 310 generates complex symbols by encoding and modulating a transmit bit string. Also, in data reception, the communication unit 310 restores a receive bit string by demodulating and decoding a baseband signal. Also, the communication unit 310 up-converts the baseband signal into an RF band signal, transmits it via an antenna, and down-converts an RF band signal received via the antenna into a baseband signal. For example, the communication unit 310 may include a transmit filter, a receive filter, an amplifier, a mixer, an oscillator, a DAC, an ADC, and the like.

Also, the communication unit 310 may include a plurality of transmit and receive paths. Further, the communication unit 310 may include an antenna unit. The communication unit 310 may include at least one antenna array including a plurality of antenna elements. In terms of the hardware, the communication unit 310 may include a digital circuit and an analog circuit (e.g., an RF integrated circuit (RFIC)). Herein, the digital circuit and the analog circuit may be implemented as a single package. Also, the communication unit 310 may include a plurality of RF chains. The communication unit 310 may perform the beamforming. The communication unit 310 may apply a beamforming weight to a signal, to assign directivity to the signal to transmit or receive according to the configuration of the control unit 330. According to an embodiment, the communication unit 310 may include an RF block (or an RF unit). The RF block may include first RF circuitry related to an antenna and second RF circuitry related to baseband processing. The first RF circuitry may be referred to as an RF-antenna (A). The second RF circuitry may be referred to as an RF-baseband (B).

Further, the communication unit 310 may transmit or receive a signal. To this end, the communication unit 310 may include at least one transceiver. The communication unit 310 may receive a downlink signal. The downlink signal may include a synchronization signal (SS), a reference signal (RS) (e.g., a cell-specific reference signal (CRS), a demodulation (DM)-RS), system information (e.g., a master information block (MIB), a system information block (SIB), remaining system information (RMSI), other system information (OSI)), a configuration message, control information, downlink data, or the like. Also, the communication unit 310 may transmit an uplink signal. The uplink signal may include a random access related signal (e.g., a random access preamble (RAP) (or message 1 (Msg1) or message 3 (Msg3)), a reference signal (e.g., a sounding reference signal (SRS), a DM-RS), a power headroom report (PHR), or the like.

Also, the communication unit 310 may include different communication modules to process signals of different frequency bands. Further, the communication unit 310 may include a plurality of communication modules to support a plurality of radio access technologies. For example, the different radio access technologies may include Bluetooth low energy (BLE), wireless fidelity (Wi-Fi), WiFi Gigabyte (WiGig), a cellular network (e.g., LTE, NR) and so on. In addition, the different frequency bands may include a super high frequency (SHF) (e.g., 2.5 GHZ, 5 GHZ) band, and the mm Wave (e.g., 30 GHz, 60 GHz) band. Also, the communication unit 310 may use the radio access technology of the same type on an unlicensed band for different frequency bands (e.g., a licensed assisted access (LAA)) and citizens broadband radio service (CBRS) (e.g., 3.5 GHZ)).

The communication unit 310 transmits and receives the signals as stated above. Hence, whole or part of the communication unit 310 may be referred to as ‘a transmitter’, ‘a receiver’, or ‘a transceiver’. In addition, the transmission and the reception over the radio channel are used as the meaning which embraces the above-stated processing of the communication unit 310 in the following explanations.

The storage unit 320 stores a basic program for operating the terminal 120, an application program, and data such as setting information. The storage unit 320 may include a volatile memory, a non-volatile memory, or a combination of a volatile memory and a non-volatile memory. The storage unit 320 provides the stored data at a request of the control unit 330.

The control unit 330 controls general operations of the terminal 120 and 130. For example, the control unit 330 transmits and receives the signal through the communication unit 310. Also, the control unit 330 records and reads data in and from the storage unit 320. The control unit 330 may execute functions of the protocol stack required by the communication standard. For doing so, the control unit 330 may include at least one processor. The control unit 330 may include at least one processor or a microprocessor, or may be part of a processor. In addition, part of the communication unit 310 and the control unit 330 may be referred to as a cellular processor (CP). The control unit 330 may include various modules for performing communication. According to various embodiments, the control unit 330 may control the terminal to perform operations according to various embodiments.

The control unit 330 may control the terminal to perform a link adaptation method for transmitting data, if traffic, such as XR traffic, has a high data rate and a packet arrival duration over a specific value. The control unit 330 may control the terminal to repeatedly receive from the base station, physical downlink shared channels (PDSCHs) including the same transport block (TB) or a TB for carrying the same RLC protocol data unit (PDU) with a different TB size from the previous transmission. The control unit 330 may control to decode the PDSCHs repeatedly received from the base station, and control not to receive and buffer PDSCHs transmitted from the base station after decoding success. The control unit 330 may control to transmit to the base station, a hybrid automatic repeat and request (HARQ) feedback message including information for identifying the PDSCH successfully decoded among the PDSCHs received from the base station.

Hereafter, the disclosure may describe embodiments based on an HARQ feedback scheme. Next, HARQ feedback methods in the communication system shall be explained. Even if a method (e.g., signal transmission or reception) performed at a first communication node (or a transmitting node) among communication nodes is described, a corresponding second communication node (or a receiving node) may perform a method (e.g., signal reception or transmission) corresponding to the method conducted at the first communication node. That is, if a terminal operation is described, a corresponding base station may perform an operation corresponding to the terminal operation. By contrast, if a base station operation is described, a corresponding terminal may perform an operation corresponding to the base station operation.

A feedback transmission and reception scheme may be used to improve reliability and efficiency in the communication system. If the transmitting node of the communication system transmits a signal, the receiving node may transmit to the transmitting node, feedback indicating information of whether the signal transmitted from the transmitting node is successfully received (i.e., whether the received signal is successfully decoded). For example, it may be the HARQ feedback in an embodiment of the communication system.

If the HARQ feedback scheme is used, the receiving node, upon successfully decoding a first signal (e.g., data) received from the transmitting node, may transmit HARQ feedback indicating the decoding success of the first signal to the transmitting node. Herein, the HARQ feedback indicating the decoding success of the first signal may correspond to acknowledgement (ACK). Meanwhile, if failing in decoding the first signal received from the transmitting node, the receiving node may transmit HARQ feedback indicating the decoding failure of the first signal to the transmitting node. Herein, the HARQ feedback indicating the decoding success of the first signal may correspond to negative ACK (NACK). If receiving the NACK from the receiving node, the transmitting node may determine reception failure of the first signal at the receiving node, and retransmit the first signal.

In an embodiment of the communication system, the receiving node may determine whether decoding is successful on a TB basis. For example, if failing in decoding or detecting an error in the TB of the first signal received from the transmitting node, the receiving node may transmit NACK of the corresponding TB. However, this is merely an example to ease the explanation, and the embodiment of the disclosure is not limited thereto. For example, the receiving node may determine whether decoding the first signal received from the transmitting node is successful on a code block (CB) basis. Alternatively, the receiving node may determine whether decoding the first signal received from the transmitting node is successful on a code block group (CBG) basis. Herein, the CBG is a group including at least one CB, and may be smaller than the TB and greater than or equal to the CB. If failing in decoding or detecting an error in some of CBs of the first signal received from the transmitting node, the receiving node may transmit NACK of the corresponding CB. If failing in decoding or detecting an error in some of CBGs of the first signal received from the transmitting node, the receiving node may transmit NACK of the corresponding CBG.

In an embodiment of the communication system, an upper node (e.g., the base station) may perform downlink transmission to a lower node (e.g., the terminal). The lower node may transmit to the upper node, HARQ feedback as the feedback of the downlink transmission from the upper node. Hereafter, an embodiment of the HARQ feedback transmission and reception method if the terminal performs the HARQ feedback on downlink data transmission from the base station to the terminal is described. However, this is merely an example to ease the explanation, and the embodiment of the disclosure is not limited thereto.

In an embodiment of the feedback transmission and reception method, the base station may transmit downlink data to the terminal on the PDSCH. The terminal may transmit HARQ feedback of the downlink data received from the base station, to the base station on a physical uplink control channel (PUCCH). Alternatively, the terminal may transmit HARQ feedback of the downlink data received from the base station, to the base station on a physical uplink shared channel (PUSCH). If successfully decoding the downlink data received from the base station, the terminal may transmit ACK to the base station. By contrast, if failing in decoding the downlink data received from the base station, the terminal may transmit NACK to the base station. The base station, upon receiving the NACK from the terminal, may determine reception failure of the downlink data transmitted to the terminal, and retransmit the downlink data.

Prior to transmitting the downlink data to the terminal through the PDSCH, the base station may transmit downlink control information (DCI) to the terminal through the PDCCH. The DCI transmitted from the base station to the terminal prior to the downlink data may be configured based on any one of DCI formats defined by 3GPP communication standard. For example, the DCI transmitted from the base station to the terminal prior to the downlink data may be configured based on DCI format 1_0, 1_1, 1_2 and the like. Alternatively, the DCI transmitted from the base station to the terminal prior to the downlink data may have a separate structure defined to support the embodiment of the feedback transmission and reception method. The DCI 1_0 transmitted from the base station to the terminal prior to the downlink data may include some or all of fields shown in Table 1. The DCI 1_1 may include some or all of fields shown in Table 2.

TABLE 1

| IE(Information Element) | size(bit) |
|---|---|
| Identifier for DCI formats | 1 |
| Frequency domain resource assignment | Variable |
| Time domain resource assignment | 4 |
| VRB-to-PRB mapping | 1 |
| Modulation and coding scheme | 5 |
| New data indicator | 1 |
| Redundancy version | 2 |
| HARQ process number | 4 |
| Downlink assignment index | 2 |
| TPC command for scheduled PUCCH | 2 |
| PUCCH resource indicator | 2 |
| PDSCH-to-HARQ_feedback timing indicator | 3 |

TABLE 2

| IE | size(bit) |
|---|---|
| Modulation and coding scheme [TB1] | 5 |
| New data indicator [TB1] | 1 |
| Redundancy version [TB1] | 2 |
| Modulation and coding scheme [TB2] | 5 |
| New data indicator [TB2] | 1 |
| Redundancy version [TB2] | 2 |
| HARQ process number | 4 |
| Downlink assignment index | 0, 2, 4 |
| TPC command for scheduled PUCCH | 2 |
| PUCCH resource indicator | 3 |
| PDSCH-to-HARQ_feedback timing indicator | 0, 1, 2, 3 |

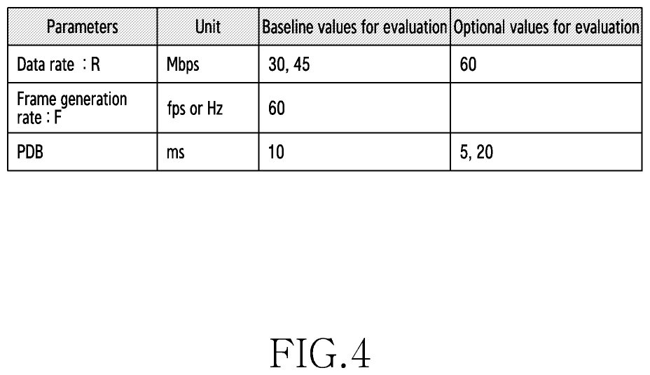

FIG. 4 illustrates statistical parameters of a single stream DL virtual reality (VR) traffic model according to an embodiment of the disclosure.

Referring to FIG. 4, the statistical parameters of the DL VR traffic model having the frame generation rate of 60 Hz may be described. According to embodiments of the disclosure, DL traffic transmitted from the base station to the terminal may be data (e.g., VR traffic or XR traffic) transmitted every 16.76 ms, and DL data transmitted every 16.76 ms may have the frame generation rate of 60 Hz (or 60 frame per second (fps)). Hence, the DL data having the frame generation rate of 60 Hz may have the data rate of 30 megabits per second (Mbps) or 45 Mbps as its baseline value for evaluation, and may have the data rate of 60 Mbps as its optional value for evaluation. The DL data having the frame generation rate of 60 Hz may have packet latency budget (PDB) of 10 ms as the evaluation baseline value, and may have the PDB of 5 ms and/or 20 ms as the optional value for evaluation. At this time, a pair (i.e., X %, PDB ms) of the packet success rate X and the PDB may be (99, 7) and/or (95, 13).

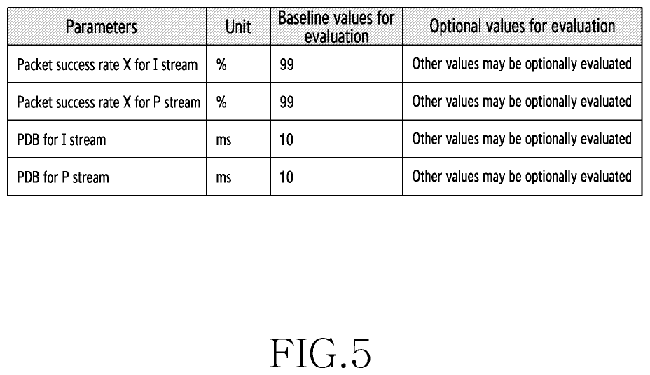

FIG. 5 illustrates statistical parameters of a multi-stream DL VR traffic model according to an embodiment of the disclosure.

Referring to FIG. 5, in the multi-stream DL VR traffic model, the evaluation baseline value and the parameters may be different from the single stream DL VR traffic model of FIG. 4. For example, in a group of pictures (GOP) including frames (or streams) transmitted every 16.67 ms (e.g., two I frames and seven P frames), the packet success rate X of the I stream may be 99% and the packet success rate X of the P stream may be 99%. In the GOP, the PDB of the I stream may be 10 ms, and the PDB of the P stream may be 10 ms.

Referring back to FIGS. 4 and 5, the DL traffic transmitted every 16.67 ms may require high throughout (e.g., 30 and/or 45 Mbps), low latency (e.g., 10 ms), and high reliability (e.g., 99%). The DL traffic may be transmitted from the base station (e.g., the gNB) in a small number of slots (e.g., one or two slots). To ensure the packet success rate and the PDB, the DL traffic may allow up to one or two HARQ retransmissions.

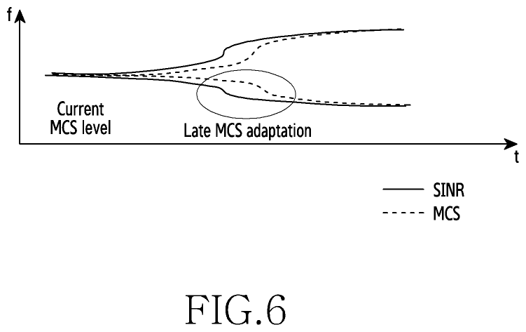

FIG. 6 illustrates modulation and coding scheme (MCS) adaptation for a signal to interference plus noise ratio (SINR) according to an embodiment of the disclosure.

Referring to FIG. 6, the link adaption method, that is, a method for transmitting data without an error by applying at least one parameter according to a change of a radio link state (e.g., SINR) may be described. A purpose of the link adaptation may be to determine at least one of an MCS level, layers, or the number of physical resource blocks (PRBs). In particular, the MCS level may be determined mainly based on the HARQ feedback (e.g., cyclic redundancy check (CRC) result). Hence, to keep up with an SINR change trend, HARQ feedback of the PDSCH transmitted in each slot may be required. For example, based on a moving window or a weight, MCS level adaptation may be performed to satisfy a target block error rate (BLER). However, since the PDSCH for XR traffic may be transmitted every 16.67 ms, it may be difficult for the conventional link adaptation method to keep up with the SINR change trend.

For example, if the SIRN increases with time, the MCS level may adapt to the SINR change late. However, if the SINR increases, a more robust MCS level may be used and accordingly there may be no problem in transmitting data without an error. However, if the SINR decreases with time, a small number of TBs are transmitted and thus it may be difficult to adapt to the SINR change due to the link adaptation. That is, since the MCS level adapts to the SINR change late, it may be difficult for the base station to transmit data without an error.

Meanwhile, a voice over LTE (VOLTE) service (e.g., a VOLTE packet generated per 20 ms) may be subject to the same problem as the DL traffic (e.g., XR traffic) transmitted every 16.67 ms as described above. However, VOLTE traffic, which carries fixed and small-sized data, may select a robust MCS level, and allocate a fixed number of resource blocks (RBs). Hence, it is hard to apply the aforementioned method to the XR traffic which carries data greater than the VOLTE packet. Thus, the XR traffic requires a new method different from the related art to address the aforementioned problem.

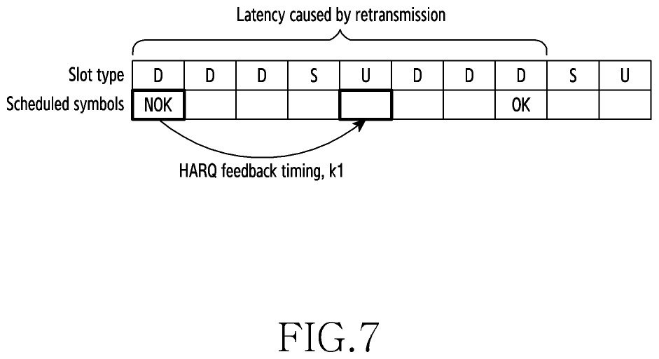

FIG. 7 illustrates latency in HARQ retransmission of a dynamic grant according to an embodiment of the disclosure.

Referring to FIG. 7, according to the conventional HARQ feedback method, problems in transmitting DL data with different redundancy versions (RVs) may be described. The 5G communication system may support various grants and scheduling schemes. Each scheme may have the following vulnerabilities. The dynamic grant may increase the latency according to the HARQ retransmission. That is, DL data (e.g., NOK) not successfully decoded may be fed back in an UL slot or a U slot according to a HARQ feedback timing (e.g., K1), and the base station may retransmit DL data (e.g., DL data with a different RV from the previously transmitted DL data) in a DL slot or a D slot based on the HARQ feedback. Thus, considerable latency may occur until the DL data of the different RV is retransmitted through the HARQ feedback after the DL data is transmitted.

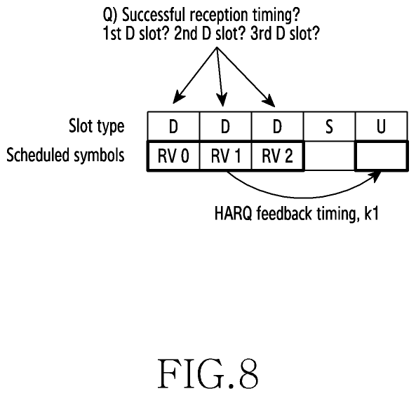

FIG. 8 illustrates HARQ retransmissions with different RVs according to an embodiment of the disclosure.

Referring to FIG. 8, problems in transmitting DL data with different RVs in a plurality of DL slots may be described. In this case, changing the RV for each DL data retransmission is to obtain an adequate gain (e.g., a forward error correction (FEC) gain) by changing a CRC position in channel coding and lowering a coding rate. If the plurality of the DL data with the different RVs is transmitted, the base station may hardly obtain which DL data transmitted is successfully decoded, based on HARQ feedbacks of the transmitted DL data.

The method for transmitting the DL data by lowering the MCS level may acquire a greater gain by lowering a required SINR threshold indicating the required SINR, than the gain of the method for repeatedly transmitting the PDSCH having the same MCS level. However, if the MCS level is decreased, data efficiency may be degraded and accordingly the data rate for one PR may be lowered. Thus, lowering the MCS level may need to use more RBs, and accordingly the MCS level decrease and the data rate may have a tradeoff relationship. However, the 5G communication system, which may perform the communication using a wider bandwidth than the LTE communication system, may achieve a higher gain by lowering the MCS level and transmitting the DL data.

The PUSCH repetition scheme may be also subject to the above-described problems. The 5G communication system may support PUSCH repetition type A and B to satisfy ultra-reliable low-latency communications (URLLC). The repetition scheme may be also applied to the PDSCH transmission. In this case, consecutive mini slots may be repeatedly transmitted at a fixed MCS level. As a result, UL resources may be wasted, and it may be hard for the transmitter to obtain whether the receiver successfully decodes the PUSCH of initial transmission or retransmission. Hence, the PUSCH repetition scheme may achieve a higher gain (e.g., decrease the required SINR threshold) by lowering the MCS level and repeatedly transmitting PUSCHs, than repeatedly transmitting the consecutive mini slots at the fixed MCS level.

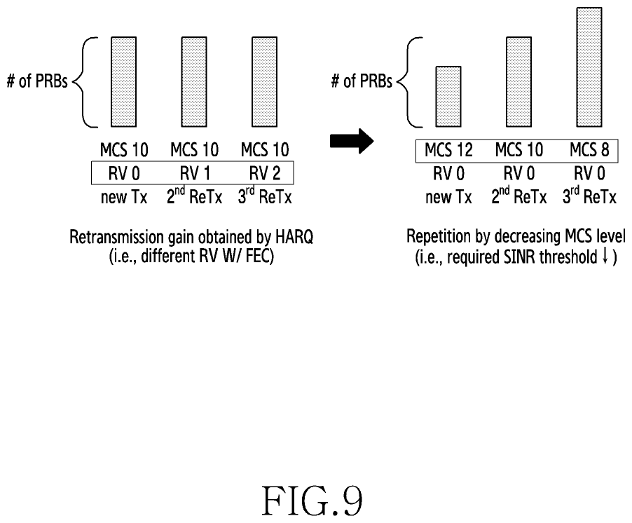

FIG. 9 illustrates a concept of a PDSCH repetitive transmission due to a MCS level decrease according to an embodiment of the disclosure.

Referring to FIG. 9, the method of the disclosure for transmitting data by decreasing the MCS level and the conventional method for transmitting data at a fixed MCS level may be described for comparison. For example, if the base station transmits data at the fixed MCS level, each data may increase the RV at every retransmission but may use the same number of PRBs in the transmission. Meanwhile, the method of the disclosure for transmitting data by decreasing the MCS level may sequentially decrease the MCS level of data retransmitted after initial transmission of data having an arbitrary MCS level, but the RV may have the same value. Notably, as the MCS level of the retransmitted data is lowered, the number of the PRBs used for the transmission may increase. Still, the MCS level decrease may lower the required SINR threshold.

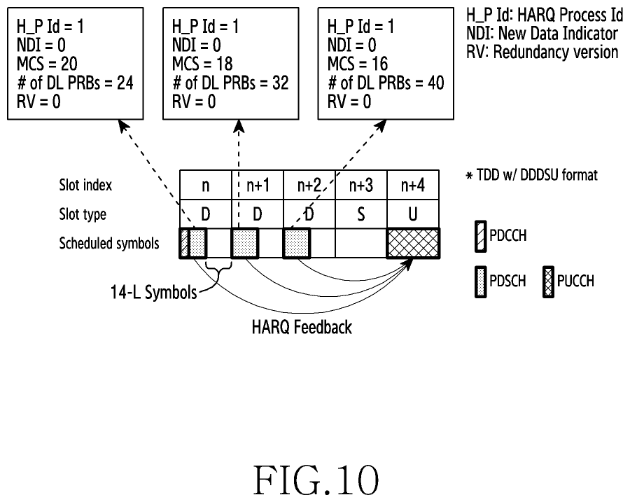

FIG. 10 illustrates a PDSCH repetitive transmission via a mini slot according to an embodiment of the disclosure.

Referring to FIG. 10, an embodiment of the method for transmitting data by decreasing the MCS level may be described. The base station may request the terminal to transmit its capability (e.g., UE capability) information, and the terminal may transmit a terminal capability report to the base station at the request of the base station. The base station may configure required information for the terminal through higher layer signaling (e.g., an RRC message) based on the terminal capability information. In so doing, the required information may include information for configuring a size of a slot (e.g., a slot including 14 symbols or a mini slot including a smaller number of symbols than a slot) for the base station to transmit the PDSCH.

The slot size (e.g., a mini slot including L-ary symbols allocated for PDSCH transmission) for carrying a plurality of PDSCHs may be configured according to the configuration information included in the RRC message. According to the configuration information included in the RRC message, the terminal may monitor the PDCCH in an n-th mini slot. The terminal may receive control information on the PDSCCH through the PDCCH monitoring. Hereafter, the control information may indicate DCI. The control information (e.g., DCI) may include information for scheduling the plurality of the PDSCHs to be transmitted from the base station in the plurality of the mini slots (e.g., including all grants of the PDSCHs to be transmitted from the base station). The base station may transmit at least one PDSCH to the terminal in at least one mini slot configured as the downlink based on the RRC message or the control information.

The terminal may receive the PDSCH from the base station in the n-th mini slot based on the control information. In so doing, receiving the PDSCH may indicate receiving DL data (e.g., XR traffic) transmitted on the PDSCH. If successfully decoding the PDSCH received in the n-th mini slot, the terminal may not receive a further PDSCH from the base station. By contrast, if failing in decoding the PDSCH received in the n-th mini slot, the terminal may receive the PDSCH in an (n+1)-th mini slot based on the control information. If successfully decoding the PDSCH received in the (n+1)-th mini slot, the terminal may not receive a further PDSCH from the base station. By contrast, if failing in decoding the PDSCH received in the (n+1)-th mini slot, the terminal may receive the PDSCH in an (n+2)-th mini slot based on the control information. Next, prior to an (n+4)-th mini slot (e.g., a HARQ feedback timing indicated by the control information), the terminal may transmit to the base station a HARQ feedback message including information for identifying whether at least one PDSCH received is successfully decoded, on the PUCCH. At this time, the plurality of the PDSCHs transmitted from the base station may include the same HARQ process identifier (H_P Id). Since the plurality of the PDSCHs transmitted from the base station includes the same data (e.g., the same TB or a TB different in size from the previous transmission but carrying the same RLC PDU) rather than new data, a new data indicator (NDI) of each PDSCH may have the value of 0.

Notably, the plurality of the PDSCHs transmitted from the base station may have a lower MCS level in each transmission. For example, if the PDSCH transmitted in the n-th mini slot has the MCS level of 20, the PDSCH transmitted in the (n+1)-th mini slot may have the MCS level of 18 and the PDSCH transmitted in the (n+2)-th mini slot may have the MCS level of 16. In this case, the MCS level is decreased by 2 in each PDSCH retransmission, but the MCS level decrease is not limited to 2. Accordingly, at every PDSCH retransmission, the MCS level may be decreased by at least 1 or more, or may be decreased by an irregular value. The plurality of the PDSCHs transmitted from the base station may use more DL PRBs in each transmission. For example, the PDSCH may be transmitted in the n-th mini slot using 24 DL PRBs, the PDSCH may be transmitted in the (n+1)-th mini slot using 32 DL PRBs, and the PDSCH may be transmitted in the (n+2)-th mini slot using 40 DL PRBs. At this time, the number of the DL PRBs increases by 8 in each PDSCH retransmission, which is not limited to 8. The number of the DL PRBs in the PDSCH retransmission may increase by at least 1 or more, or may increase by an irregular value.

Notably, the RV of the PDSCH transmitted in each mini slot has the same value, but it is not limited to the same RV value. The RV of the PDSCH transmitted in each mini slot may be configured (or indicated) to have a different value, depending on a combining scheme of the retransmitted data (e.g., at least one of chase combining (CC) or incremental redundancy (IR)).

Meanwhile, the information for identifying whether at least one PDSCH is successfully decoded, included in the HARQ feedback message may be transmitted as follows.

According to an embodiment, the terminal may transmit the decoding success or failure of each PDSCH transmitted from the base station, using a codebook (e.g., 0 for NACK, 1 for ACK). In this case, 0 may indicate a PDSCH not received (or a skipped PDSCH) after the terminal successfully decodes the PDSCH. Thus, the information for identifying the decoding success or failure of each PDSCH, transmitted from the terminal to the base station, may include 3 bits in size.

According to an embodiment, the terminal may transmit the decoding success or failure of each PDSCH transmitted from the base station, using 2 bits for identifying a PDSCH number corresponding to CRC OK (e.g., ACK). For example, 00 may indicate the decoding success of the PDSCH transmitted in the n-th (mini) slot. 01 may indicate the decoding success of the PDSCH transmitted in the (n+1)-th (mini) slot, and the decoding failure of the PDSCH transmitted in the n-th (mini) slot. 10 may indicate the decoding success of the PDSCH transmitted in the (n+2)-th (mini) slot, and the decoding failure of the PDSCH transmitted in the (n+1)-th (mini) slot. 11 may indicate the decoding failure of the PDSCHs transmitted in the n-th, (n+1)-th, and (n+2)-th (mini) slots.

Hence, compared to the 3-bit codebook including the 1-bit information indicating the decoding success or failure of each PDSCH, the 2-bit codebook for identifying the PDSCH number corresponding to the ACK may further include information of the PDSCH successfully decoded by the terminal (e.g., MCS level information of the PDSCH successfully decoded), and may reduce overhead due to the HARQ feedback. Thus, the base station may identify the MCS level of the PDSCH successfully decoded by the terminal, and transmit a PDSCH to the terminal at the identified MCS level in next transmission.

Meanwhile, the description of FIG. 10 is not limited to the PDSCH transmission. The description of FIG. 10 may be applied to PUSCH transmission from the terminal to the base station in the same manner and/or a similar manner to the same effect.

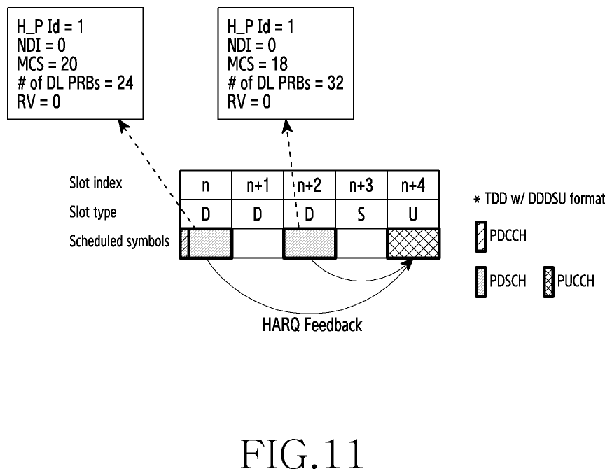

FIG. 11 illustrates a PDSCH repetitive transmission via a slot according to an embodiment of the disclosure.

Referring to FIG. 11, an embodiment of the method for transmitting data by decreasing the MCS level shall be described. The base station may request the terminal to transmit capability information of the terminal, and the terminal may transmit a terminal capability report to the base station at the request of the base station. The base station may configure necessary information for the terminal through higher layer signaling (e.g., an RRC message) based on the terminal capability information. In so doing, the required information may include information for configuring a size of a slot (e.g., a slot including 14 symbols or a mini slot including a smaller number of symbols than a slot) for the base station to transmit the PDSCH.

Slots (e.g., slots including 14 symbols) may be configured to carry a plurality of PDSCHs according to the configuration information included in the RRC message. According to the configuration information included in the RRC message, the terminal may perform the PDCCH monitoring in an n-th slot. The terminal may receive control information on the PDSCCH through the PDCCH monitoring. The control information may include information for scheduling the plurality of the PDSCHs to be transmitted from the base station in the plurality of the slots (e.g., including all grants of the PDSCHs to be transmitted from the base station). The base station may transmit at least one PDSCH to the terminal in at least one slot configured as the downlink based on the RRC message or the control information.

The terminal may receive the PDSCH from the base station in the n-th mini slot based on the control information. In so doing, receiving the PDSCH may indicate receiving DL data (e.g., XR traffic) transmitted on the PDSCH. If successfully decoding the PDSCH received in the n-th slot, the terminal may not receive a further PDSCH from the base station. By contrast, if failing in decoding the PDSCH received in the n-th slot, the terminal may receive a PDSCH in an (n+2)-th slot based on the control information. Next, prior to an (n+4)-th slot (e.g., a HARQ feedback timing indicated by the control information), the terminal may transmit to the base station a HARQ feedback message including information for identifying whether at least one PDSCH received is successfully decoded, on the PUCCH. At this time, the plurality of the PDSCHs transmitted from the base station may include the same H_P Id. Since the plurality of the PDSCHs transmitted from the base station includes the same data (e.g., the same TB or a TB different in size from the previous transmission but carrying the same RLC PDU) rather than new data, the NDI of each PDSCH may have the value of 0.

Notably, the plurality of the PDSCH transmitted from the base station may have a lower MCS level in each transmission. For example, if the PDSCH transmitted in the n-th slot has the MCS level of 20, the PDSCH transmitted in the (n+2)-th slot may have the MCS level of 18. At this time, the MCS level is decreased by 2 in each PDSCH retransmission, but the MCS level decrease is not limited to 2. Accordingly, at every PDSCH retransmission, the MCS level may be decreased by at least 1 or more, or may be decreased by an irregular value. The plurality of the PDSCH transmitted from the base station may use more DL PRBs in each transmission. For example, the PDSCH may be transmitted in the n-th slot using 24 DL PRBs, and the PDSCH may be transmitted in the (n+2)-th slot using 32 DL PRBs. In this case, the number of the DL PRBs increases by 8 in each PDSCH retransmission, which is not limited to 8. The number of the DL PRBs in the PDSCH retransmissions may increase by at least 1 or more, or may increase by an irregular value.

Notably, the RV of the PDSCH transmitted in each slot has the same value, but it is not limited to the same RV value. The RV of the PDSCH transmitted in each slot may be configured (or indicated) to have a different value, depending on the combining scheme of the retransmitted data (e.g., at least one of CC or IR).

Meanwhile, the information for identifying whether at least one PDSCH is successfully decoded, included in the HARQ feedback message may be transmitted as follows.

According to an embodiment, the terminal may transmit the decoding success or failure of each PDSCH transmitted from the base station, using the codebook (e.g., 0 for NACK, 1 for ACK). In this case, 0 may indicate a PDSCH not received (or a skipped PDSCH) after the terminal successfully decodes the PDSCH. Thus, the information for identifying the decoding success or failure of each PDSCH, transmitted from the terminal to the base station, may include 2 bits in size.

According to an embodiment, the terminal may transmit the decoding success or failure of each PDSCH transmitted from the base station, using 2 bits for identifying a PDSCH number corresponding to CRC OK (e.g., ACK). For example, 00 may indicate the decoding success of the PDSCH transmitted in the n-th slot. 01 may indicate the decoding success of the PDSCH transmitted in the (n+1)-th slot, and the decoding failure of the PDSCH transmitted in the n-th slot. 10 may indicate the decoding failure of the PDSCHs transmitted in the n-th and (n+1)-th slots.

Hence, compared to the 2-bit codebook including the 1-bit information indicating the decoding success or failure of each PDSCH, the 2-bit codebook for identifying the PDSCH number corresponding to the ACK may further include information of the PDSCH successfully decoded by the terminal (e.g., MCS level information of the PDSCH successfully decoded). Thus, the base station may identify the MCS level of the PDSCH successfully decoded, and transmit the PDSCH to the terminal at the identified MCS level in next transmission.

Meanwhile, the description of FIG. 11 is not limited to the PDSCH transmission. The description of FIG. 11 may be applied to PUSCH transmission from the terminal to the base station in the same manner and/or a similar manner to the same effect.

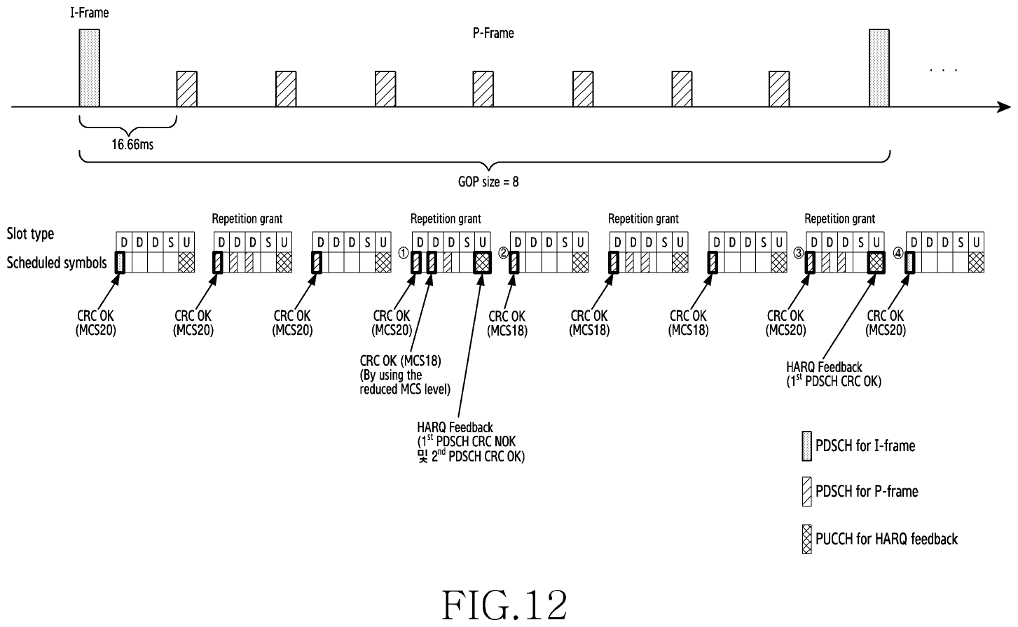

FIG. 12 illustrates PDSCH repetitive transmissions in a GOP frame according to an embodiment of the disclosure.

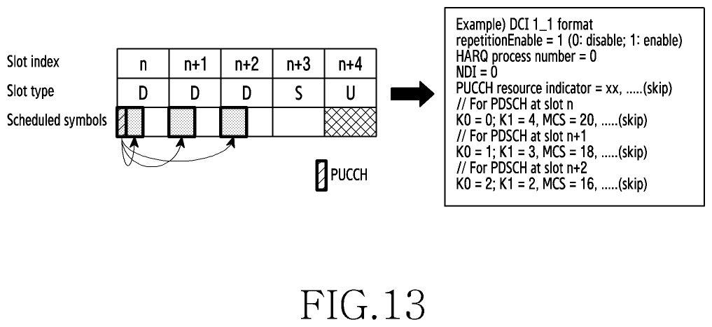

Referring to FIG. 12, an embodiment of the method for transmitting data by decreasing the MCS level in the GOP frame as explained in FIG. 5 shall be described. Control information (e.g., DCI 1_1 of Table 2 as described above) including a single-PDSCH grant may be defined as a nominal grant. Control information including a multi-PDSCH grant may be defined as a repetition grant. In this case, the multi-PDSCH grant may indicate a first PDSCH and PDSCHs to be repeated through DCI 1_1 including IEs to be suggested. The IEs to be included in DCI 1_1 of the multi-PDSCH grant shall be elucidated in FIGS. 13, 14, and 15.

According to an embodiment, DL data periodically transmitted may use a periodic-based grant. In this case, the number of the repetition grants and the number of the nominal grants may be used in the ratio of 1:N (e.g., N is an integer equal to greater than 1). For example, if the DCI indicates the repetition grant in a situation □ of FIG. 12, the terminal may receive the first PDSCH with the MCS level of 20. If failing in decoding the first PDSCH, the terminal may receive a second PDSCH of the MCS level of 18. By contrast, if successfully decoding the second PDSCH, the terminal may not receive a further PDSCH. The terminal may transmit to the base station a HARQ feedback message including information for identifying the decoding success or failure of each PDSCH previously transmitted, on the PUCCH. Next, based on the information included in the HARQ feedback message received from the terminal, the base station may identify that the MCS level of the PDSCH successfully decoded by the terminal is 18. Hence, the base station may repeatedly transmit a plurality of PDSCHs with the MCS level of 18 by using the nominal grant, without using the repetition grant, in a next P frame (e.g., a situation □ of FIG. 12). Thus, the base station may minimize radio resource waste by not always using the repetition grant, and may transmit (DL) data to the terminal without retransmission risk even if the link state is unexpectedly degraded.

According to an embodiment, an event-based repetition grant may be used. For example, if MCS level up is determined by a link adaptation algorithm of each vendor (the situation □ of FIG. 12), the base station may use the repetition grant. In this case, the base station may identify that the terminal successfully decodes the PDSCH of the MCS level of 18, based on the HARQ feedback message received from the terminal in a previous P frame (e.g., a sixth P frame). However, according to determining the MCS level up, the base station may transmit to the terminal a PDSCH having a greater MCS level (e.g., 20) than the PDSCH successfully decoded, using the repetition grant. Next, the base station may repeatedly transmit a PDSCH by decreasing the MCS level according to the repetition grant, and identify whether the terminal successfully receives the PDSCH of the increased MCS level, based on the HARQ feedback message received from the terminal. The base station may repeatedly transmit PDSCHs of the increased MCS level (e.g., 20) using the nominal grant in a next I frame (e.g., a situation □ of FIG. 12) according to whether the MCS level up is successful or not. Hence, even if the link state does not allow the MCS level up, the base station may transmit (DL) data without retransmission risk, using the repetition grant.

Meanwhile, the description of FIG. 12 is not limited to the PDSCH transmission. The description of FIG. 12 may be applied to PUSCH transmission from the terminal to the base station in the same manner and/or a similar manner to the same effect.

FIG. 13 illustrates an embodiment of control information configuration for each PDSCH repetition according to an embodiment of the disclosure.

Referring to FIG. 13, control information for the PDSCH repetition may include the following characteristics. First, the base station may indicate all grants of the PDSCHs to be repeatedly transmitted through one control information. Hence, if performing the PDCCH monitoring and receiving the control information over the PDCCH, the terminal may not perform the PDCCH monitoring to receive PDSCHs to be repeatedly transmitted after an initial PDSCH.

The control information for the PDSCH repetition may include the following IEs. The control information for the PDSCH repetition may include a 1-bit indicator (e.g., repetitionEnable) for indicating whether the PDSCH repetition is performed. For example, if repetitionEnable has the value of 1 (e.g., enable), the base station may trigger the PDSCH repetition. However, if repetitionEnable has the value of 1, it may indicate no PDSCH repetition (e.g., disable), and the indicator value of 1 is not always fixed to the PDSCH repetition. If the PDSCH repetition is indicated (or, enabled), the terminal may not perform the PDCCH monitoring on slots repeated after the PDCCH reception, and may receive a PDSCH only if a previous PDSCH is CRC NOK (i.e., NACK). Notably, the base station may indicate the H_P Id, the NDI, and a PUCCH resource identifier for HARQ feedback to the terminal using the existing IDs (e.g., at least one of Table 1 or 2 as described earlier).

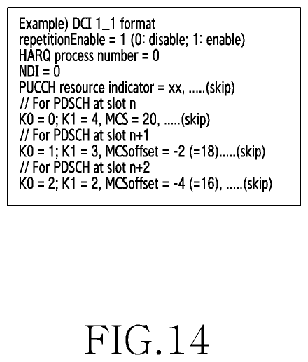

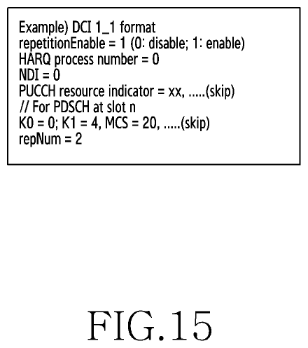

The control information may further include separate IEs for the grant of each PDSCH in the PDSCH repetition. In so doing, the base station may indicate the grant of each PDSCH to the terminal using the existing IDs (e.g., at least one of Table 1 or 2 as described earlier) to indicate at least one of a gap between the PDCCH and the PDSCH (e.g., K0), the HARQ feedback timing (e.g., K1), time domain resource allocation (e.g., a start and length indicator value (SLIV)), frequency domain resource allocation (e.g., frequency domain resource allocation (FDRA), the MCS level, the number of layers, or the RV value. For example, referring back to FIG. 10, the grant of the PDSCH transmitted in the n-th (mini) slot may be indicated as K0=0, K1=4, and MCS=20, the grant of the PDSCH transmitted in the (n+1)-th (mini) slot may be indicated as K0=1, K1=3, and MCS=18, and the grant of the PDSCH transmitted in the (n+2)-th (mini) slot may be indicated as K0=2, K1=2, and MCS=16. However, the IE for indicating the MCS level of each PDSCH among the aforementioned IEs may be indicated to the terminal using various methods, to be elucidated in FIGS. 14 and 15.

Meanwhile, the description of FIG. 13 is not limited to the PDSCH transmission. The description of FIG. 13 may be applied to PUSCH transmission from the terminal to the base station in the same manner and/or a similar manner to the same effect.

FIG. 14 illustrates an embodiment of control information configuration for each PDSCH repetition according to an embodiment of the disclosure.

Referring to FIG. 14, as the method for indicating the MCS level for grants of a first PDSCH and PDSCHs repeated thereafter, a method for using an MCS offset value shall be described. For example, referring back to FIG. 10, the base station may set an individual MCS level for the grant of the first PDSCH (e.g., the PDSCH of the n-th (mini) slot) according to the method for indicating the MCS level of FIG. 13 (e.g., the method for directly indicating the MCS level of each PDSCH). Hence, configuration information of the first PDSCH may including the existing IEs (e.g., at least one of Table 1 or 2 mentioned above) as in FIG. 13. However, the base station may indicate the MCS level to the terminal through the MCS offset with respect to the grants of the PDSCHs to be repeated in (mini) slots. Thus, control information for the grants of the repeated PDSCHs may include an IE indicating the MCS offset (e.g., MCSoffset).

According to an embodiment, the MCS offset value may be indicated as a value (e.g., a positive or negative integer) which increases or decreases from the MCS level of the first PDSCH. For example, the base station may indicate the MCS offset value for the grants of the PDSCHs to be repeated after the first PDSCH.

According to an embodiment, the MCS offset value may be indicated as a specific value (e.g., a negative integer) which decreases from the MCS level of the first PDSCH. For example, the base station may indicate only once the specific decrease value of the MCS level for the grants of the PDSCHs to be repeated after the first PDSCH.

Hence, if indicating the MCS level using the MCS offset value, the base station may indicate the MCS level for each PDSCH to the terminal with smaller bits than the method for directly indicating the MCS value, and thus may reduce control information transmission overhead for indicating the MCS level of each PDSCH.

Meanwhile, the description of FIG. 14 is not limited to the PDSCH transmission. The description of FIG. 14 may be applied to PUSCH transmission from the terminal to the base station in the same manner and/or a similar manner to the same effect.

FIG. 15 illustrates an embodiment of control information configuration for each PDSCH repetition according to an embodiment of the disclosure.

Referring to FIG. 15, a method for indicating a grant of each PDSCH if a first PDSCH and PDSCHs repeated thereafter have the same MCS, layers, SLIV, and FDRA shall be described. For example, the grants of the first PDSCH and the PDSCHs repeated thereafter may use the existing IEs (e.g., at least one of Table 1 or 2 mentioned above) as in FIG. 13. However, an IE for notifying the terminal of the number of repetitions may be further included.

According to an embodiment, through an IE (e.g., repNum) indicating the number of the PDSCH repetitions, the base station may indicate to the terminal the grants of the PDSCHs repeated as many as the PDSCH repetitions with the same values. For example, by setting the grants of the PDSCHs repeated as many as the PDSCH repetitions to the same values only once, the base station may reduce control information transmission overhead for indicating the grants of the PDSCHs.

According to an embodiment, based on the size of control information (e.g., uplink control information (UCI)) for transmitting a HARQ feedback message from the terminal to the base station on the PUCCH, the number the PDSCH repetitions may be determined (or, indicated). For example, if the UCI includes 2 bits, information for identifying a PDSCH successfully decoded by the terminal, included in the HARQ feedback message may be represented with 2 bits (e.g., 00, 01, 10, 11), and the number of the PDSCH repetitions may be indicated as 3 because two bits may represent up to three PDSCHs. Likewise, if the UCI includes 3 bits, the information for identifying a PDSCH successfully decoded by the terminal in the HARQ feedback message may be represented with 3 bits (e.g., 000 through 110), and the number of the PDSCH repetitions may be indicated as 7 because 3 bits may represent up to seven PDSCHs.

Meanwhile, the description of FIG. 15 is not limited to the PDSCH transmission. The description of FIG. 15 may be applied to PUSCH transmission from the terminal to the base station in the same manner and/or a similar manner to the same effect.

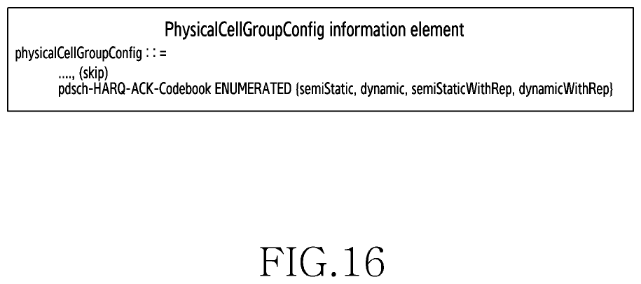

FIG. 16 illustrates an embodiment of control information configuration for each PDSCH repetition according to an embodiment of the disclosure.

Referring to FIG. 16, higher layer signaling (e.g., an RRC message) including HARQ codebook configuration information shall be explained. For example, the RRC message may include at least one of “semiStatic” or “dynamic”, as IEs for configuring codebook information to the terminal. “semiStatic” may be the IE for feeding back whether decoding is successful with respect to every PDSCH, and “dynamic” may be the IE for feeding back the number of at least one PDSCH successfully decoded by the terminal.

Also, the RRC message may include at least one of “semiStatic WithRep” or “dynamicWithRep”, as IEs for configuring HARQ codebook information for the PDSCH repetition to the terminal. “semiStatic WithRep” and “dynamic WithRep” are configuration information for the repetition grant, and may be applied to the embodiment for transmitting the HARQ message in the form of the 2-bit codebook of FIG. 10.

Meanwhile, the description of FIG. 16 is not limited to the PDSCH transmission. The description of FIG. 16 may be applied to PUSCH transmission from the terminal to the base station in the same manner and/or a similar manner to the same effect.

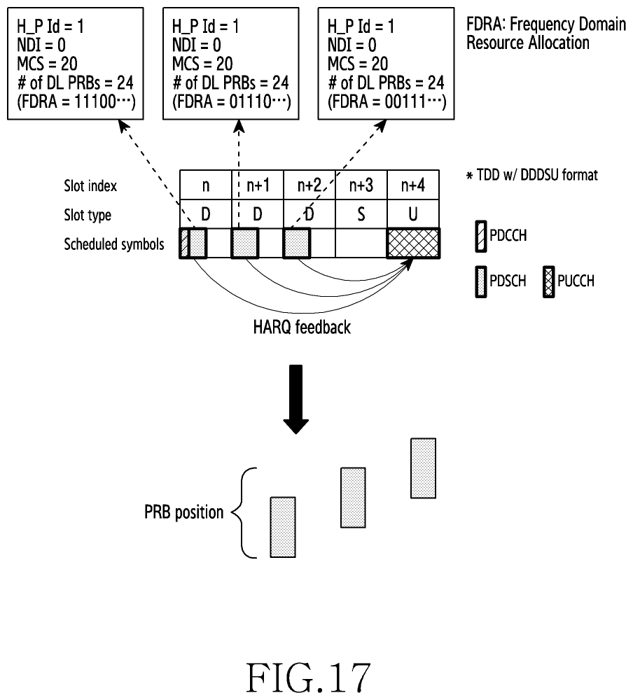

FIG. 17 illustrates PDSCH repetitive transmissions with different PRB positions according to an embodiment of the disclosure.

Referring to FIG. 17, an embodiment of a method for transmitting data of the same MCS level at different PRB positions shall be described. FIG. 17 may be described based on the same slot format as FIG. 10, and accordingly redundant description thereof shall be omitted.

The terminal may receive the PDSCH from the base station in the n-th mini slot based on control information. In so doing, receiving the PDSCH may indicate receiving DL data (e.g., XR traffic) on the PDSCH. The terminal may decode the PDSCH received in the n-th mini slot. Regardless of whether the PDSCH received in the n-th mini slot is successfully decoded or not, the terminal may receive the PDSCH in the (n+1)-th mini slot based on the control information. The terminal may decode the PDSCH received in the (n+1)-th mini slot. Regardless of whether the PDSCH received in the (n+1)-th mini slot is successfully decoded, the terminal may receive the PDSCH in the (n+2)-th mini slot based on the control information. In this case, the plurality of the PDSCHs transmitted from the base station may include the same H_P Id. Since the plurality of the PDSCHs transmitted from the base station includes the same data (e.g., the same TB or a TB different in size from the previous transmission but carrying the same RLC PDU) rather than new data, the NDI of each PDSCH may have the value of 0.

However, unlike the embodiment of FIG. 10, the plurality of the PDSCHs transmitted from the base station may have the same MCS level. For frequency diversity, the plurality of the PDSCHs transmitted from the base station may be transmitted to the terminal using PRBs of different positions. Thus, the control information may further include a bitmap-type FDRA value indicating different frequency allocation resources to indicate the grant of each PDSCH. In the FDRA bitmap, 1 may indicate that 8 PRBs are allocated, and 0 may indicate that 8 PRBs are not allocated. For example, the FDRA bitmap ‘11100 . . . ’ may indicate that first through 24th RPBs are allocated, and the FDRA bitmap ‘01110 . . . ’ may indicate that ninth through 32th RPBs are allocated.

Accordingly, unlike the embodiment of FIG. 10, the terminal may receive the first PDSCH and the repeated PDSCHs regardless of a CRC result (e.g., decoding success or failure) of a previous PDSCH. The terminal may transmit to the base station a HARQ feedback message including decoding results of the first PDSCH and the repeated PDSCHs. Based on the decoding results of the first PDSCH and the repeated PDSCHs included in the HARQ feedback message, the base station may determine which PRB position is optimal for the PDSCH transmission.

Meanwhile, information for identifying the decoding success or failure of at least one PDSCH included in the HARQ feedback message transmitted from the terminal to the base station may be transmitted as follows. According to an embodiment, the terminal may transmit the decoding success or failure of each PDSCH received from the base station in the form of the codebook (e.g., 0 for NACK, 1 for ACK). In so doing, a PDSCH not received at the terminal after the PDSCH decoding success may be expressed as 0. Hence, the information for identifying the decoding success or failure of each PDSCH transmitted from the terminal to the base station may include 3 bits.

Meanwhile, the description of FIG. 17 is not limited to the PDSCH transmission. The description of FIG. 17 may be applied to PUSCH transmission from the terminal to the base station in the same manner and/or a similar manner to the same effect.

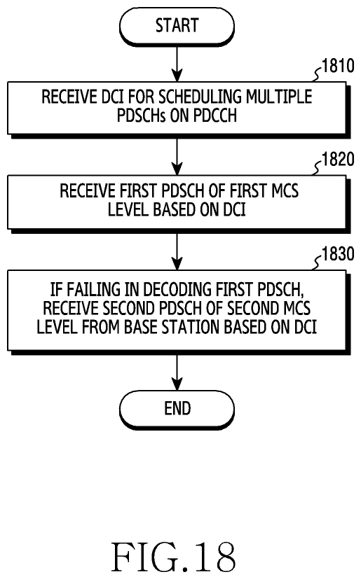

FIG. 18 illustrates a flowchart of a terminal according to an embodiment of the disclosure.

Referring to FIG. 18, the flowchart of the terminal for receiving and decoding at least one repetition PDSCH from the base station based on the DCI received from the base station according to aforementioned embodiments shall be described. Notably, FIG. 10 may include the operations of the terminal in the embodiments as mentioned earlier and accordingly redundant description thereof shall be omitted.

In operation 1810, the terminal may receive DCI for scheduling a plurality of PDSCHs from the base station on the PDCCH. At this time, the terminal may perform the PDCCH monitoring to receive the DCI from the base station. The DCI may include a 1-bit indicator (e.g., repetitionEnable) for indicating whether the PDSCH repetition is performed. For example, if repetitionEnable has the value of 1 (e.g., enable), the base station may trigger the PDSCH repetition. However, if repetitionEnable has the value of 1, it may indicate no PDSCH repetition (e.g., disable), and the indicator value of 1 is not always fixed to the PDSCH repetition. If the PDSCH repetition is indicated (or, enabled), the terminal may not perform the PDCCH monitoring on slots repeated after the PDCCH reception, and may receive the PDSCH only if a previous PDSCH is CRC NOK (i.e., NACK).

The DCI received from the base station may include information for scheduling the plurality of the PDSCHs for carrying the repetition grant from the base station in a plurality of (mini) slots. Specifically, the DCI may include all the grants of the repeatedly transmitted PDSCHs, and the grant of each PDSCH may be indicated to the terminal according to at least one of the embodiments of FIG. 13 or 14.

In operation 1820, the terminal may receive a first PDSCH of a first MCS level from the base station based on the DCI received from the base station. At this time, receiving the PDSCH may indicate receiving DL data (e.g., XR traffic) on the PDSCH. The terminal may decode the received first PDSCH.

In operation 1830, if failing in decoding the first PDSCH, the terminal may receive a second PDSCH of a second MCS level from the base station based on the DCI received from the base station. The terminal may decode the received second PDSCH. In so doing, the second MCS level may have a smaller value than the first MCS level of operation 1820.

Meanwhile, the description of FIG. 18 is not limited to the PDSCH transmission. The description of FIG. 18 may be applied to PUSCH transmission from the terminal to the base station in the same manner and/or a similar manner to the same effect.

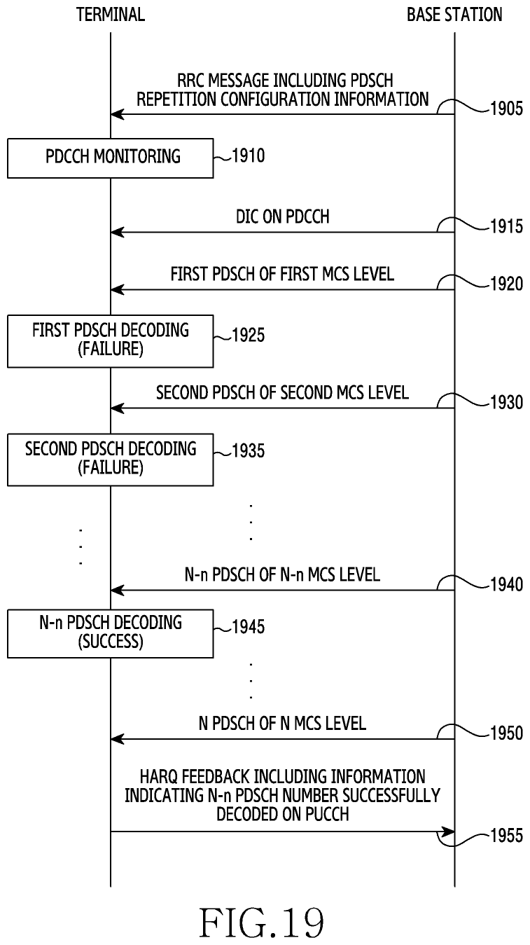

FIG. 19 illustrates signal flows between a terminal and a base station according to an embodiment of the disclosure.

Referring to FIG. 19, the signal flows between the terminal and the base station to perform the repetition PDSCH shall be described according to an embodiment of the disclosure.

In operation 1905, the base station may transmit an RRC message including PDSCH repetition configuration information to the terminal. In so doing, the PDSCH repetition configuration information included in the RRC message may be configured based on terminal capability information received from the terminal. Specifically, the PDSCH repetition configuration information may include information for the base station to set the slot size (e.g., at least one of a slot including 14 symbols or a mini slot including a smaller number of symbols than the slot) for carrying the repetition PDSCH according to the terminal capability. The base station may semi-statically or dynamically configure the HARQ feedback of the terminal through the PDSCH repetition configuration information according to the embodiment of FIG. 16.

In operation 1910, the terminal may perform the PDCCH monitoring based on the configuration information included in the RRC message received in operation 1905.

In operation 1915, the terminal may receive DCI from the base station on the PDCCH through the PDCCH monitoring. In this case, the DCI received from the base station may include a 1-bit indicator (e.g., repetitionEnable) for indicating whether the PDSCH repetition is performed. For example, if repetitionEnable has the value of 1 (e.g., enable), the base station may trigger the PDSCH repetition. However, if repetitionEnable has the value of 1, it may indicate no PDSCH repetition (e.g., disable), and the indicator value of 1 is not always fixed to the PDSCH repetition. If the PDSCH repetition is indicated (or, enabled), the terminal may not perform the PDSCCH monitoring on slots repeated after the PDCCH reception, and may receive a PDSCH only if a previous PDSCH is CRC NOK (i.e., NACK). In addition, the DCI received from the base station may include information for scheduling the plurality of the PDSCHs for carrying the repetition grant from the base station in a plurality of (mini) slots. Specifically, the DCI may include all the grants of the repeatedly transmitted PDSCHs, and the grant of each PDSCH may be indicated to the terminal according to at least one of the embodiments of FIG. 13 or 14.

In operation 1920, the base station may transmit a first PDSCH of a first MCS level to the terminal based on the DCI. The terminal may receive the first PDSCH of the first MCS level from the base station based on the DCI. At this time, receiving the first PDSCH may be scheduling by the grant of the first PDSCH included in the DCI, and the terminal may receive the first PDSCH regardless of whether a previous PDSCH is successfully decoded.

In operation 1925, the terminal may decode the first PDSCH received from the base station. If successfully decoding the first PDSCH, the terminal may not further receive PDSCHs from the base station. However, although the terminal does not further receive PDSCHs, the base station may sequentially transmit PDSCHs of the decreased MCS level to the terminal in N-ary slots configured as downlink transmission.

In operation 1930, the base station may transmit a second PDSCH of a second MCS level to the terminal based on the DCI. If failing in decoding the first PDSCH received from the base station, the terminal may receive the second PDSCH of the second MCS level from the base station based on the DCI. At this time, receiving the second PDSCH may be scheduling by the grant of the second PDSCH included in the DCI, and the terminal may not perform the PDCCH monitoring to receive the second PDSCH.

In operation 1935, the terminal may decode the second PDSCH received from the base station. If successfully decoding the second PDSCH, the terminal may not further receive PDSCHs from the base station. However, although the terminal does not further receive PDSCHs, the base station may sequentially transmit PDSCHs of the decreased MCS level to the terminal in N-ary slots configured as downlink transmission.

In operation 1940, regardless of whether the terminal successfully decodes the previously transmitted PDSCH, the base station may transmit an (N-n)-th PDSCH of an N-n MCS level to the terminal based on the DCI. By contrast, if failing in decoding the PDSCH previously received from the base station, the terminal may repeat receiving the PDSCH in slots configured as the downlink transmission according to the slot format configured by the RRC message and decoding the received PDSCH (e.g., operation 1930 and operation 1935). Hence, if failing in decoding the PDSCH previously received, the terminal may receive the (N-n)-th PDSCH of the N-n MCS level from the base station based on the DCI. For example, the number of the slots configured as the downlink transmission may be N, and n may be a positive integer smaller than N. The reception of the (N-n)-th PDSCH may be scheduled by a grant of the (N-n)-th PDSCH included in the DCI, and the terminal may not perform the PDCCH monitoring to receive the (N-n)-th PDSCH.

In operation 1945, the terminal may decode the (N-n)-th PDSCH received from the base station. If successfully decoding the (N-n)-th PDSCH, the terminal may not further receive PDSCHs from the base station. However, although the terminal does not further receive n-ary PDSCHs, the base station may sequentially transmit the n-ary PDSCHs of the decreased MCS level to the terminal in n-ary slots configured as the downlink transmission.

In operation 1950, the base station may transmit an N-th PDSCH of an N MCS level to the terminal based on the DCI. At this time, the terminal may not receive the N-th PDSCH.

In operation 1955, the terminal may transmit to the base station a HARQ feedback message including information for identifying the (N-n)-th PDSCH successfully decoded, on the PUCCH. For example, the terminal may transmit the information for identifying the (N-n)-th PDSCH successfully decoded, to the base station according to at least one of the embodiments of the HARQ feedback method of FIG. 10. Thus, the base station may identify the MCS level value (e.g., N-n) of the PDSCH successfully decoded by the terminal, based on the HARQ feedback message received from the terminal.

Meanwhile, the description of FIG. 19 is not limited to the PDSCH transmission. The description of FIG. 19 may be applied to PUSCH transmission from the terminal to the base station in the same manner and/or a similar manner to the same effect.

According to various embodiments of the disclosure, a method performed by a terminal for PDSCH repetition in a wireless communication system may include receiving DCI which schedules a plurality of PDSCHs from a base station on a PDCCH, receiving a first PDSCH of a first MCS level from the base station based on the DCI, and, if failing in decoding the first PDSCH, receiving a second PDSCH of a second MCS level from the base station based on the DCI, the first MCS level and the second MCS level may be indicated through the DCI, and the second MCS level may be smaller than the first MCS level.

In an embodiment, the method may further include transmitting a feedback message including information of decoding success or failure of the first PDSCH and the second PDSCH, to the base station on a PUCCH, and the information may include information for identifying a PDSCH successfully decoded among the plurality of the PDSCHs.

In an embodiment, the DCI may further include HARQ process identifiers and NDIs for the first PDSCH and the second PDSCH, a first HARQ process identifier for the first PDSCH and a second HARQ process identifier for the second PDSCH may be the same, a first NDI for the first PDSCH and a second NDI for the second PDSCH may be the same, and the first PDSCH and the second PDSCH may relate to at least one of the same TB or a TB for carrying the same RLC PDU.

In an embodiment, the DCI may further include at least one of an indicator of the PDSCH repetition, a grant of the PDSCH repetition, a time gap between the DCI reception and each PDSCH transmission, or a time gap between the DCI reception and the feedback message transmission.

In an embodiment, if the first PDSCH is successfully decoded, receiving the second PDSCH may be skipped.

According to various embodiments of the disclosure, a method performed by a base station for PDSCH repetition in a wireless communication system may include transmitting DCI which schedules a plurality of PDSCHs to a terminal on a PDCCH, transmitting a first PDSCH of a first MCS level to the terminal based on the DCI, and transmitting a second PDSCH of a second MCS level to the terminal based on the DCI, the first MCS level and the second MCS level may be indicated through the DCI, and the second MCS level may be smaller than the first MCS level.

In an embodiment, the method may further include receiving a feedback message including information of decoding success or failure of the first PDSCH and the second PDSCH, from the terminal on a PUCCH, and the information may include information for identifying a PDSCH successfully decoded among the plurality of the PDSCHs.

In an embodiment, the DCI may further include HARQ process identifiers and NDIs for the first PDSCH and the second PDSCH, a first HARQ process identifier for the first PDSCH and a second HARQ process identifier for the second PDSCH may be the same, a first NDI for the first PDSCH and a second NDI for the second PDSCH may be the same, and the first PDSCH and the second PDSCH may relate to at least one of the same TB or a TB for carrying the same RLC PDU.

In an embodiment, the DCI may further include at least one of an indicator of the PDSCH repetition, a grant of the PDSCH repetition, a time gap between the DCI reception and each PDSCH transmission, or a time gap between the DCI reception and the feedback message transmission.

In an embodiment, if the first PDSCH is decoded successfully, receiving the second PDSCH may be skipped.

According to various embodiments of the disclosure, a terminal in a wireless communication system may include at least one transceiver and at least one processor functionally coupled with the at least one transceiver, the at least one processor may be configured to receive DCI which schedules a plurality of PDSCHs from a base station on a PDCCH, receive a first PDSCH of a first MCS level from the base station based on the DCI, and if failing in decoding the first PDSCH, receive a second PDSCH of a second MCS level from the base station based on the DCI, the first MCS level and the second MCS level may be indicated through the DCI, and the second MCS level may be smaller than the first MCS level.

In an embodiment, a feedback message including information of decoding success or failure of the first PDSCH and the second PDSCH may be transmitted to the base station on a PUCCH, and the information may include information for identifying a PDSCH successfully decoded among the plurality of the PDSCHs.

In an embodiment, the DCI may further include HARQ process identifiers and NDIs for the first PDSCH and the second PDSCH, a first HARQ process identifier for the first PDSCH and a second HARQ process identifier for the second PDSCH may be the same, a first NDI for the first PDSCH and a second NDI for the second PDSCH may be the same, and the first PDSCH and the second PDSCH may relate to at least one of the same TB or a TB for carrying the same RLC PDU.

In an embodiment, the DCI may further include at least one of an indicator of the PDSCH repetition, a grant of the PDSCH repetition, a time gap between the DCI reception and each PDSCH transmission, or a time gap between the DCI reception and the feedback message transmission.

In an embodiment, if the first PDSCH is decoded successfully, receiving the second PDSCH may be skipped.

According to various embodiments of the disclosure, a base station in a wireless communication system may include at least one transceiver and at least one processor functionally coupled with the at least one transceiver, the at least one processor may be configured to transmit DCI which schedules a plurality of PDSCHs to a terminal on a PDCCH, transmit a first PDSCH of a first MCS level to the terminal based on the DCI, and transmit a second PDSCH of a second MCS level to the terminal based on the DCI, the first MCS level and the second MCS level may be indicated through the DCI, and the second MCS level may be smaller than the first MCS level.

In an embodiment, a feedback message including information of decoding success or failure of the first PDSCH and the second PDSCH may be received from the terminal on a PUCCH, and the information may include information for identifying a PDSCH successfully decoded among the plurality of the PDSCHs.

In an embodiment, the DCI may further include HARQ process identifiers and NDIs for the first PDSCH and the second PDSCH, a first HARQ process identifier for the first PDSCH and a second HARQ process identifier for the second PDSCH may be the same, a first NDI for the first PDSCH and a second NDI for the second PDSCH may be the same, and the first PDSCH and the second PDSCH may relate to at least one of the same TB or a TB for carrying the same RLC PDU.

In an embodiment, the DCI may further include at least one of an indicator of the PDSCH repetition, a grant of the PDSCH repetition, a time gap between the DCI reception and each PDSCH transmission, or a time gap between the DCI reception and the feedback message transmission.

In an embodiment, if the first PDSCH is decoded successful, receiving the second PDSCH may be skipped.

The methods according to the embodiments described in the claims or the specification of the disclosure may be implemented in software, hardware, or a combination of hardware and software.

As for the software, a non-transitory computer-readable storage medium storing one or more programs (software modules) may be provided. One or more programs stored in the non-transitory computer-readable storage medium may be configured for execution by one or more processors of an electronic device. One or more programs may include instructions for controlling an electronic device to execute the methods according to the embodiments described in the claims or the specification of the disclosure.

Such a program (software module, software) may be stored to a random access memory, a non-volatile memory including a flash memory, a read only memory (ROM), an electrically erasable programmable ROM (EEPROM), a magnetic disc storage device, a compact disc (CD)-ROM, a digital versatile disc (DVD) or other optical storage device, and a magnetic cassette. Alternatively, it may be stored to a memory combining part or all of those recording media. A plurality of memories may be included.

Also, the program may be stored in an attachable storage device accessible via a communication network such as internet, intranet, local area network (LAN), wide LAN (WLAN), or storage area network (SAN), or a communication network by combining these networks. Such a storage device may access a device which executes an embodiment of the disclosure through an external port. In addition, a separate storage device on the communication network may access the device which executes an embodiment of the disclosure.

In the specific embodiments of the disclosure, the components included in the disclosure are expressed in a singular or plural form. However, the singular or plural expression is appropriately selected according to a proposed situation for the convenience of explanation, the disclosure is not limited to a single component or a plurality of components, the components expressed in the plural form may be configured as a single component, and the components expressed in the singular form may be configured as a plurality of components.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) for physical downlink shared channel (PDSCH) repetition in a wireless communication system, the method comprising:
receiving, from a base station, downlink control information (DCI) which schedules a plurality of PDSCHs on a physical downlink control channel (PDCCH);
receiving, from the base station, a first PDSCH of a first modulation and coding scheme (MCS) level based on the DCI; and
receiving, from the base station, a second PDSCH of a second MCS level based on the DCI in case that decoding of the first PDSCH fails,
wherein the first MCS level and the second MCS level are indicated through the DCI, and the second MCS level is smaller than the first MCS level.

2. The method of claim 1, further comprising:
transmitting, to the base station, a feedback message comprising information of decoding success or failure of the first PDSCH or the second PDSCH on a physical uplink control channel (PUCCH),
wherein the information comprises information for identifying a PDSCH successfully decoded among the plurality of the PDSCHs.

3. The method of claim 1,
wherein the DCI further comprises hybrid automatic repeat and request (HARQ) process identifier and new data indicator (NDI) for each of the first PDSCH and the second PDSCH, and
wherein the first PDSCH and the second PDSCH relate to at least one of the same transport block (TB) or a TB for carrying the same radio link control (RLC) protocol data unit (PDU).

4. The method of claim 2, wherein the DCI further comprises at least one of an indicator of the PDSCH repetition, a grant of the PDSCH repetition, a time gap between the DCI reception and each PDSCH transmission, or a time gap between the DCI reception and the feedback message transmission.

5. The method of claim 1, wherein the receiving of the second PDSCH is skipped in case that the first PDSCH is successfully decoded.

6. A method performed by a base station for physical downlink shared channel (PDSCH) repetition in a wireless communication system, the method comprising:
transmitting, to a user equipment (UE), downlink control information (DCI) which schedules a plurality of PDSCHs on a physical downlink control channel (PDCCH);
transmitting, to the UE, a first PDSCH of a first modulation and coding scheme (MCS) level based on the DCI; and
transmitting, to the UE, a second PDSCH of a second MCS level based on the DCI,
wherein the first MCS level and the second MCS level are indicated through the DCI, and the second MCS level is smaller than the first MCS level.

7. The method of claim 6, further comprising:
receiving, from the UE, a feedback message comprising information of decoding success or failure of the first PDSCH or the second PDSCH on a physical uplink control channel (PUCCH),
wherein the information comprises information for identifying a PDSCH successfully decoded among the plurality of the PDSCHs.

8. The method of claim 6,
wherein the DCI further comprises hybrid automatic repeat and request (HARQ) process identifier and new data indicator (NDI) for each of the first PDSCH and the second PDSCH, and
wherein the first PDSCH and the second PDSCH relate to at least one of the same transport block (TB) or a TB for carrying the same radio link control (RLC) protocol data unit (PDU).

9. The method of claim 7, wherein the DCI further comprises at least one of an indicator of the PDSCH repetition, a grant of the PDSCH repetition, a time gap between the DCI reception and each PDSCH transmission, or a time gap between the DCI reception and the feedback message transmission.

10. The method of claim 6, wherein receiving of the transmitted second PDSCH is skipped in case that the first PDSCH is successfully decoded by the UE.

11. A user equipment (UE) for physical downlink shared channel (PDSCH) repetition in a wireless communication system, the UE comprising:
a transceiver; and
at least one processor operatively coupled with the transceiver and configured to:
receive, from a base station, downlink control information (DCI) which schedules a plurality of PDSCHs on a physical downlink control channel (PDCCH),
receive, from the base station, a first PDSCH of a first modulation and coding scheme (MCS) level based on the DCI, and
receive, from the base station, a second PDSCH of a second MCS level based on the DCI in case that decoding of the first PDSCH fails,
wherein the first MCS level and the second MCS level are indicated through the DCI, and the second MCS level is smaller than the first MCS level.

12. The UE of claim 11,
wherein the at least one processor is further configured to:
transmit, to the base station, a feedback message comprising information of decoding success or failure of the first PDSCH or the second PDSCH on a physical uplink control channel (PUCCH), and
wherein the information comprises information for identifying a PDSCH successfully decoded among the plurality of the PDSCHs.

13. The UE of claim 11,
wherein the DCI further comprises hybrid automatic repeat and request (HARQ) process identifier and new data indicator (NDI) for each of the first PDSCH and the second PDSCH, and
wherein the first PDSCH and the second PDSCH relate to at least one of the same transport block (TB) or a TB for carrying the same radio link control (RLC) protocol data unit (PDU).

14. The UE of claim 12, wherein the DCI further comprises at least one of an indicator of the PDSCH repetition, a grant of the PDSCH repetition, a time gap between the DCI reception and each PDSCH transmission, or a time gap between the DCI reception and the feedback message transmission.

15. The UE of claim 11, wherein the reception of the second PDSCH is skipped in case that the first PDSCH is successfully decoded.

16. A base station for physical downlink shared channel (PDSCH) repetition in a wireless communication system, the base station comprising:
a transceiver, and
at least one processor operatively coupled with the transceiver and configured to:
transmit, to a user equipment (UE), downlink control information (DCI) which schedules a plurality of PDSCHs on a physical downlink control channel (PDCCH),
transmit, to the UE, a first PDSCH of a first modulation and coding scheme (MCS) level based on the DCI, and
transmit, to the UE, a second PDSCH of a second MCS level based on the DCI,
wherein the first MCS level and the second MCS level are indicated through the DCI, and the second MCS level is smaller than the first MCS level.

17. The base station of claim 16,
wherein the at least one processor is further configured to:
receive, from the UE, a feedback message comprising information of decoding success or failure of the first PDSCH or the second PDSCH on a physical uplink control channel (PUCCH), and
wherein the information comprises information for identifying a PDSCH successfully decoded among the plurality of the PDSCHs.

18. The base station of claim 16,
wherein the DCI further comprises hybrid automatic repeat and request (HARQ) process identifier and new data indicator (NDI) for each of the first PDSCH and the second PDSCH, and
wherein the first PDSCH and the second PDSCH relate to at least one of the same transport block (TB) or a TB for carrying the same radio link control (RLC) protocol data unit (PDU).

19. The base station of claim 17, wherein the DCI further comprises at least one of an indicator of the PDSCH repetition, a grant of the PDSCH repetition, a time gap between the DCI reception and each PDSCH transmission, or a time gap between the DCI reception and the feedback message transmission.

20. The base station of claim 16, wherein receiving of the transmitted second PDSCH is skipped in case that the first PDSCH is successfully decoded by the UE.
